(19) United States
(12) Patent Application Publication
(10) Pub. No.: US 2014/0009589 A1
(43) Pub. Date: Jan. 9, 2014

(54) VEHICLE HAVING A DEVICE FOR DETECTING THE SURROUNDINGS OF SAID VEHICLE

(71) Applicant: Joachim Gloger, Bibertal (DE)

(72) Inventor: Joachim Gloger, Bibertal (DE)

(73) Assignee: Daimler AG, Stuttgart (DE)

(21) Appl. No.: 13/822,361

(22) PCT Filed: Dec. 8, 2011
(86) PCT No.: PCT/EP2011/006158

§ 371 Date: Mar. 12, 2013

(30) Foreign Application Priority Data
Feb. 10, 2011 (DE) 10 2011 010 865.3

(51) Int. Cl. B60R 1/00

(52) U.S. Cl. CPC B60R 1/00
USPC 348/51; 348/148

(57) ABSTRACT

A vehicle (1) with a device (2) for monitoring an environment of a vehicle. The device (2) comprises a plurality of image-capturing units (3 to 10), the capture ranges (E3 to E 10) at least partially overlapping each other and forming at least one overlap range, wherein an overall image (G) of the vehicle environment can be generated from the individual images (B3 to B10) captured by means of the image-capturing units (3 to 10) using an image-processing unit (11). The image-capturing units (3 to 10) are configured as wafer-level cameras and integrated in vehicle body components in a front zone, in a rear zone, and in side zones of the vehicle (1).

The invention relates to a vehicle with a device for monitoring a vehicle environment, wherein the device comprises a plurality of image-capturing units, the capture ranges thereof at least partially overlapping and forming at least one overlap range, and wherein an overall image of the vehicle environment can be generated by means of an image-processing unit from individual images captured by the image-capturing units.

Vehicles with devices for monitoring and depicting a vehicle environment are known to the prior art, wherein an image of the vehicle and its environment can be displayed to a driver of said vehicle. Better all-around visibility is thus created for the driver, serving the latter as an assist function or support while driving.

DE 10 2009 051 526 A1 discloses a device for depicting a vehicle environment with a settable or adjustable perspective. The device comprises at least one sensor means on the vehicle, wherein said at least one sensor means is configured to measure distances to objects in the vehicle environment. The device further comprises a processor with which a three-dimensional map of the environment based on the measured distances of the at least one sensor means can be generated. Further provision is made of a display for depicting the three-dimensional map of the environment with a viewpoint that can be adjusted according to a particular driving situation.

US 2006/0018509 A1 describes a device for generating an image for the conversion of an image perspective based on a plurality of image data, i.e., a stereoimage is generated from a plurality of perspective images. The device comprises a first unit with two cameras with different viewpoints for capturing first image data. Further provision is made of a second unit with two other cameras with different viewpoints for capturing second image data, wherein an optical axis of an optical lens of at least one of the cameras of the second unit runs parallel to an optical axis of an optical lens of one of the cameras of the first unit. The units are furthermore arranged such that the optical axes of the two cameras of each unit are not configured parallel to each another.

The objective of the invention is to provide an improved vehicle over the prior art with a device for monitoring a vehicle environment.

The object is achieved according to the invention with a vehicle having the features of claim 1.

Advantageous embodiments of the invention are the subject of the dependent claims.

A vehicle comprises a device for monitoring a vehicle environment, wherein the device comprises a plurality of image-capturing units, the capture ranges thereof at least partially overlapping and forming at least one overlap range, and wherein an overall image of the vehicle environment can be generated by means of an image-processing unit from individual images captured by the image-capturing units.

According to the invention, the image-capturing units are configured as wafer-level cameras and integrated in vehicle body components in a front zone, in a rear zone, and in side zones of the vehicle.

Owing to the arrangement of the image-capturing units and the configuration as wafer-level cameras, with the device of the invention it is possible to capture the vehicle environment very precisely and thus determine spatial conditions and objects with high precision using stereoscopic image-processing. In addition to acquisition of distance information for warning purposes, the information thus obtained can also be used for a complete and accurate portrayal of the vehicle environment on any display unit. This is also possible for virtual image-capturing units determined by calculation, since the sizes of objects and the distances thereof in the vehicle environment, i.e., in the world, are known in a particularly advantageous manner. A spatial representation of the vehicle environment is possible if the display unit is configured for a three-dimensional display. In order to render hazardous situations more visible, it is also possible to generate artificial, virtual views based on the knowledge of the spatial conditions of the vehicle environment in which non-essential components can be depicted with, for example, lower intensity and essential components can be depicted with greater intensity in the overall image. A construction of the overall image from virtual and real image components and thus a representation as “augmented reality” is also possible.

Furthermore, wafer-level cameras can be produced at low cost. Wafer-level cameras also require very little installation space, hence nearly any arrangement on the vehicle is possible.

With a large number of mounted wafer-level cameras, the entire surroundings of the vehicle can be captured expediently and without the need of complicated pivot mechanisms for an individual camera.

Better all-around visibility is thus created for the driver, serving the latter as an assist function or support while driving, for example when maneuvering the vehicle. It is furthermore possible to prevent accidents, which frequently occur due to poor all-around visibility, in particular with large and difficult to manage vehicles.

Hence the device enables the achievement of a so-called “surround view system”, which shows the entire vehicle environment at close range around the vehicle, and of a so-called “top view system”, which shows the vehicle and its environment at close range from a bird's eye view. In contrast to the devices known to the prior art, a projection surface is not required for the achievement of a virtual top view camera, since three-dimensional information is known from the vehicle surroundings. Thus areas above or below and/or in front of or in back of the zone of the projection surface can be displayed on the overall image without distortion, wherein three-dimensional information can be generated and displayed thanks to the overlap ranges between the image-capturing units.

An example of embodiment of the invention will be explained in more detail in the following, with reference to a drawing.

Shown is:

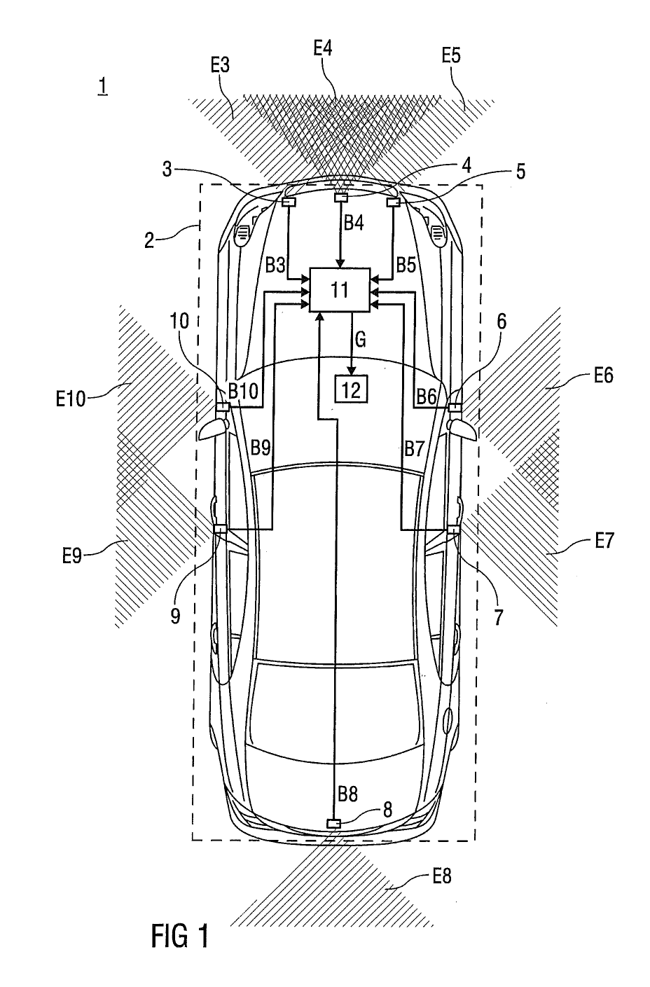

FIG. 1 A schematically illustrated vehicle of the invention with a device for monitoring a vehicle environment.

The single FIG. 1 shows a possible example of embodiment of the vehicle 1 of the invention, which comprises a device 2 for monitoring a vehicle environment.

The device 2 comprises a plurality of image-capturing units 3 to 10, wherein said image-capturing units 3 to 10 are each configured as wafer-level cameras.

Wafer-level cameras are understood to mean cameras that are produced by means of so-called WLC technology (WLC=wafer-level camera). In WLC technology, optical lenses are set directly on a wafer. The production of wafer-level cameras is similar to mounting circuits on a wafer. Thus a large number, in particular thousands of optical lenses are mounted simultaneously on a wafer, and then aligned and cemented thereon. By using so-called wafer stack technology it is possible to dispense with the necessary but cost-intensive mounting and alignment of individual lenses of a standard production method. Lastly, the individual wafer-level cameras are cut out of the wafer and mounted on a sensor module. A major advantage of this technique resides in the low production costs. Furthermore, the 2.5 millimetre in size wafer-level cameras are only around half as large as the smallest standard camera modules. Alternatively, however, these wafer-level cameras can also be stacked with optical lenses after they are cut out. In this case higher-order designed optic lenses can also be used while otherwise retaining the basic features of the production method.

In order to portray the vehicle environment or at least critical zones of the vehicle environment that lie outside the driver's direct field of vision (in so-called blind spots) as completely as possible, the wafer-level cameras are integrated in vehicle body components in a front zone, in a rear zone, and in side zones of the vehicle 1 and aligned therein such that the portrayed capture ranges E3 to E10 thereof each partially overlap. In other words: partial areas of the portrayed vehicle environment are monitored by a plurality of wafer-level cameras and form an overlap range in each case.

The image-capturing units 3 to 5 are arranged on the front end of the vehicle 1 and monitor an area in front of the vehicle. In addition to generating the overall image G, they are provided, say, as a parking assist or for the operation of other driver assist systems such as a lane-keeping system, a night vision assist, traffic sign recognition, and/or for object recognition. The image-capturing units 3 to 5 are in particular integrated in a hood, a radiator grill, a bumper, a spoiler, and/or a panelling element.

The image-capturing units 6, 7, 9, 10 are integrated in the side zones of the vehicle 1, in body components thereof, and provided for monitoring areas of the vehicle environment alongside the vehicle 1. In addition to generating the overall image G, image-capturing units 6, 7, 9, 10 are provided for the operation of, say, a so-called blind spot assist. The image-capturing units 6, 7, 9, 10 are in particular integrated in a side mirror, a rail, doors, an A, B, C, and/or D column, and/or in a panelling element.

On the rear end of the vehicle 1 is disposed the image-capturing unit 8, which is provided for monitoring an area behind the vehicle 1 and in addition to generating the overall image G, is preferably provided as a rear view backup camera. The image-capturing unit 8 is in particular integrated in a tailgate, a bumper, a taillight, and/or in a panelling element.

By means of the image-capturing units 3 to 10, individual images B3 to B10 are captured and transmitted to an image-processing unit 11. By means of said image-processing unit 11, the individual images B3 to B10 are processed into an overall image G, which preferably shows the vehicle 1 in the vehicle environment. In other words, the image-capturing units 3 to 10 and the individual images B3 to B10 captured thereby are combined such that the overall image G is generated, wherein the overall image G preferably represents the vehicle environment and the vehicle 1 three-dimensionally.

Other numbers and arrangements are possible as alternatives to the illustrated arrangement and number of image-capturing units 3 to 10 on the vehicle 1.

The arrangement of the image-capturing units 3 to 10 in the front zone, rear zone, and side zones of the vehicle 2 enables the generation of an overall image G, which portrays the vehicle environment completely and true to detail. Owing to the particularly small size of the wafer-level cameras, the image-capturing units 3 to 10 are very easily integrated without adversely affecting the appearance of the vehicle 1.

The image-capturing units 3 to 10 can thus be arranged linearly and/or non-linearly adjacent to one another.

A linear arrangement gives rise to the advantage of a simple, in particular stereoscopic processing of the individual images B3 to B10 into the overall image G. Alternatively or additionally, however, calculations with any other number of image-capturing units 3 to 10 are also conceivable, wherein for example a trinocular stereoprocessing of individual images B3 to B10 into an overall image G is effected.

For the stereoscopic and/or trinocular calculation, knowledge of the base widths (i.e., the distances between the individual image-capturing units 3 to 10) is required, wherein different base widths are achieved by means of variable and appropriate interconnections of a plurality, particularly of two image-capturing units 3 to 10. The base width is thus easily varied by actuating different image-capturing units 3 to 10. For example, image-capturing units 3 to 10 spaced far apart from one another can capture images with a large base width. Analogously, image-capturing units 3 to 10 in close proximity to one another can record images with a small base width. Owing to the arrangement of the image-capturing units 3 to 10 and the configuration as wafer-level cameras, the adjustment of the base widths can be effected without complicated mechanisms for adjusting the image-capturing units 3 to 10.

Additional flexibility in connection with the device of the invention is achieved by at least two of the image-processing units (3 to 10) having different focal lengths. Preference herein is given to two directly adjacent image-processing units (3 to 10) forming a camera pair within an array of wafer-level cameras. However, two or more image-processing units (3 to 10) not directly adjacent to one another forming one/a plurality of camera pair(s) within an array of wafer-level cameras are also conceivable. Different distance ranges around the vehicle can thus be resolved in a particularly profitable manner.

Owing to the large volume of data generated by the recorded images, the image-processing unit 11 is expediently arranged in immediate spatial proximity to the image-capturing units 3 to 10 in the vehicle 1 in order to minimise the number and length of the cables. Alternatively, a wireless data transfer between the image-capturing units 3 to 10 and the image-processing unit 11 is also possible. The small installation space of the image-capturing units 3 to 10 renders standard wiring with plugs difficult. Hence flexible circuit boards can also be used in a particularly profitable manner, wherein a plurality of image-capturing units (3 to 10) is arranged on a flexible circuit board. Advantageously, only one plug on the end of the circuit board is then needed. It is particularly advantageous if the circuit board is constructed such that the image-capturing units 3 to 10 can fit directly in the openings provided on the vehicle body.

To ensure an even more robust monitoring of the vehicle environment, the image-processing unit 11 is coupled with other sensors for monitoring the vehicle environment. To this end, the image-capturing units 3 to 10 are fused with the sensors such that a fusion of the image data captured by the image-capturing units 3 to 10 and sensor data is effected in the determination of the overall image G. The other sensors include in particular ultrasound, radar, lidar, and laser sensors as well as other cameras.

The other cameras are configured as infrared cameras in order to improve the optical detection of the vehicle environment in situations with inadequate lighting such as dark parking garages or outdoors at night. Preference is given to activation only when the lighting is inadequate for daylight processing of the captured individual images B3 to B10. The infrared cameras are in particular components of a night vision assist system.

A precise determination of the vehicle environment, spatial conditions in the vehicle environment, and objects located therein is thus possible regardless of the time of day and the lighting.

A number of image-capturing units 3 to 10 are alternatively or additionally configured as infrared cameras so as to ensure the detection of the vehicle environment when the lighting is inadequate. Hence additional infrared cameras are not needed for achieving the function of the night vision assist system.

For displaying the overall image G, a display unit 12 is preferably provided in the interior of the vehicle 1, wherein said display unit 12 is configured for a three-dimensional and hence a spatial display of the overall image G. The display unit 12 is in particular configured as a so-called autostereoscopic display.

In an improvement, preference is also given to the option of combining the representation of the three-dimensional overall image G with a three-dimensional representation of a navigation device, wherein the display unit 12 is provided for displaying the overall image G as well as for displaying the navigation information.

By the combination of the individual images B3 to B10 of the image-capturing units and/or by the fusion of the individual images B3 to B10 with the sensor data of the other sensors, it is possible to calculate virtual image-capturing units, since owing to said combination and/or fusion sizes and distances of objects in the vehicle environment are known. The vehicle environment and the vehicle 1 therein can thus be portrayed from any perspective.

In addition to acquisition of information on the distance of the vehicle 1 from objects in the vehicle environment for warning purposes, the information captured by the image-capturing units 3 to 10 and/or the other sensors and processed by the image-processing unit 11 is also suitable for the correct and complete portrayal of the vehicle environment and of the vehicle 1 on the display unit 12. In order to ensure better visibility in hazardous situations, on the basis of the knowledge of the spatial conditions in the vehicle environment it is also possible to generate and visually display artificial, virtual views, wherein the intensity of non-essential components is preferably reduced in said artificial, virtual views. In contrast, the intensity of essential components in the overall image G is preferably increased. Furthermore, the overall image G can be a mixture of real image components and virtual image components, thus making a so-called “augmented reality” achievable.

### LIST OF REFERENCE NUMERALS

1 Vehicle
2 Device
3 bis 10 Image-capturing unit
11 Image-processing unit
12 Display unit
B3 to B10 Individual image
E3 to E10 Capture range
G Overall image

1. A vehicle (1) with a device (2) for monitoring a vehicle environment, wherein said device (2) comprises a plurality of image-capturing units (3 to 10), the capture ranges (E3 to E10) thereof at least partially overlapping and forming at least one overlap range, wherein with the aid of an image-processing unit (11), an overall image (G) of the vehicle environment can be generated from individual images (B3 to B10) captured by the image-capturing units (3 to 10), and wherein the image-capturing units (3 to 10) are configured as wafer-level cameras and integrated in vehicle body components in a front zone, in a rear zone, and in side zones of the vehicle (1).

2. The vehicle (1) as in claim 1, wherein at least a number of the image-capturing units (3 to 10) are arranged linearly adjacent to one another.

3. The vehicle (1) as in claim 1, wherein at least a number of the image-capturing units (3 to 10) are not arranged linearly adjacent to one another.

4. The vehicle (1) according to claim 1, wherein the image-capturing units (3 to 10) are arranged on a flexible circuit board.

5. The vehicle (1) according to claim 1, wherein the image-processing unit (11) is coupled with sensors for monitoring the vehicle environment, wherein a fusion of the image data captured by the image-capturing units (3 to 10) and sensor data is effected in the determination of the overall image (G).

6. The vehicle (1) according to claim 1, wherein the image-processing unit (11) is coupled with at least one display unit (12), wherein the display unit (12) is configured for a three-dimensional display of the overall image (G).

7. The vehicle (1) according to claim 1, wherein a number of the image-processing units (3 to 10) are configured as infrared cameras.

8. The vehicle (1) according to claim 1, wherein the overall image (G) is formed from virtual and/or real image components.

9. The vehicle (1) according to claim 1, wherein at least two of the image-capturing units (3 to 10) have different focal lengths.
